(19) United States
(12) Patent Application Publication
(10) Pub. No.: US 2010/0082746 A1
(43) Pub. Date: Apr. 1, 2010

(54) SYSTEM AND METHOD FOR WEB SITE DRIVEN COLLABORATIVE WEB BROWSING

(76) Inventors: Sean M. Ulrich, Morrisville, NC (US); Peter G. Gaucher, Cary, NC (US); David C. Challener, Raleigh, NC (US); Jennifer G. Zawacki, Hillsborough, NC (US); James J. Thrasher, Efland, NC (US); Justin T. Dubs, Durham, NC (US); Julie A. Morris, Raleigh, NC (US)

Correspondence Address: FERENCE & ASSOCIATES LLC, 409 BROAD STREET, PITTSBURGH, PA, 15143, US

(21) Appl. No.: 12/242,855

(22) Filed: Sep. 30, 2008

(51) Int. Cl. G06F 15/16

(52) U.S. Cl. 709/204

(57) ABSTRACT

The invention provides a system comprising: a CPU; a memory in communication with the CPU; instructions stored in the memory and executable by the CPU to establish a collaborative web browsing session, the instructions further comprising: instructions enabling at least one peer device to join the collaborative web browsing session at a web site hosted by an automated peer.

### FIELD OF THE INVENTION

This invention relates generally to computing systems and in particular to providing systems, methods and arrangements for enabling users of different computing devices to establish and share a web-browsing session with one another while allowing a web site to drive the collaborative session.

### BACKGROUND OF THE INVENTION

There is an increasing desire on the part of two or more parties to participate in a collaborative web-browsing session. One common example is a shared online shopping experience. For instance, one person looking at a new product online may wish to ask another (remotely located) person “do you like this”? The first person would normally then follow up (or couple to) the question by a sending a link (i.e. a Uniform Resource Locator (URL)) to the web page containing the picture of the product currently being viewed to the other person. That is, send the second person a link to the currently viewed web page such that upon clicking the link, a web browser would open the page for viewing by the second person. If additional people were involved (e.g. the first person wanted to have the opinions of others as well), a similar process for sharing the link and the related information would be followed, e.g. via pasting a link into instant messenger.

In collaborative web browsing information is shared between users. When one user navigates to a URL, this new URL is sent to other users in the collaborative session. Their local browsers then navigate to that URL as well. Thus, there is a human being directing the session at any given time. The person is directing the flow of the navigation to the various web sites. Thus, a human input into the collaborative web browsing session is required in order to drive the session.

Therefore, there is a need for a solution that addresses the shortcomings of the arrangements summarized above.

### SUMMARY OF THE INVENTION

In summary, one aspect of the invention provides a system comprising: a CPU; a memory in communication with the CPU; instructions stored in the memory and executable by the CPU to establish a collaborative web browsing session, the instructions further comprising: instructions enabling at least one peer device to join the collaborative web browsing session at a web site hosted by an automated peer.

Another aspect of the present invention provides a method comprising: enabling at least one peer device to join the collaborative web browsing session at a web site hosted by an automated peer.

Another aspect of the present invention provides a program storage device readable by machine, tangibly embodying a program of instructions executable by the machine to perform a method comprising: enabling at least one peer device to join the collaborative web browsing session at a web site hosted by an automated peer.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 is a block diagram of a computing device.

FIG. 2 is a depiction of a collaborative web browsing system.

FIG. 3 is a block diagram of an apparatus (300) for establishing a collaborative web browsing session.

FIG. 4 is a flow chart depicting the joining of a collaborative web browsing session by a peer device.

FIG. 5 is a flow chart depicting a collaborative web browsing session driven by the web site itself.

FIG. 6 is a block diagram of a server (605) that can itself join as a user/automated peer.

### DESCRIPTION OF THE PREFERRED EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention herein described while still achieving the favorable results of this invention. Accordingly, the description which follows is to be understood as being a broad, teaching disclosure directed to persons of skill in the appropriate arts, and not as limiting upon the present invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but does not necessarily, all refer to the same embodiment.

This detailed description will first start with an overview of the instant invention and then provide a more detailed discussion of specific preferred embodiments of the invention with reference to the accompanying drawings. The scope of the invention will be pointed out in the appended claims.

Some helpful background information on enhanced URL sharing may be found in co-pending and commonly assigned U.S. patent application Ser. No. 12/050,813 “Apparatus, System, and Method for Uniform Resource Locator Sharing”, filed on Mar. 18, 2008, which is herein incorporated by reference as if fully set forth herein. According to this system, URLs may be shared in order to keep all viewers in a session viewing the same web page. Thus, it allows users to enhance the shared browsing experience by enabling each involved in the session to view the web page.

Some further background information on enhanced URL sharing may be found in co-pending and commonly assigned U.S. Patent Application “Collaborative Web Navigation Using Document Object Model (DOM) Based References” (Attorney Docket No. RPS920080038-US-NP), filed concurrently herewith and incorporated by reference as if set forth in its entirety herein. According to this system, users are not constrained to URLs sharing during a collaborative browsing session.

According to one embodiment of the instant invention, a user (using a computer) can independently navigate to a web page at the user's leisure without leading or following others in the session if they choose not to do so while participating in a collaborative web browsing session. Upon entering collaborative web browsing session enabled web sites, the user would be recognized as having an enabled device and added to the session for that particular web page (e.g. by passing a cookie from the web site to the user). The user's device would obtain session user information containing a list of other session users at the web page (e.g. in a display tab of the browser display on the user's device). This list would be automatically populated upon the user joining the session. The user may chat, comment, suggest, etc. with the other users in the session via available communication tabs in the browser view. However, if a user clicks a link, this will not automatically bring the rest of the users in the session to the same web page (e.g. via URL sharing). Instead, by clicking the link, the session user that clicked the link will be navigated to that URL while the others users in the session (e.g. directed by the web page, another user, or no leader at all) will not be forced to follow if they do not choose to do so. The new web page a user has navigated to may be another collaborative web browsing session-enabled page. If so, the user will again be enabled to join the session for that page, have his or her session user list again populated automatically, etc.

According to an embodiment of the invention, users may open a session specific web browser, a chat window, a list of bookmarks etc., all in one convenient view (e.g. via a plurality of tabs), so as to provide a plurality of users engaged in a collaborative browsing session with one another's navigation data/information. The users participating in the session may pass navigation information/data back and forth between themselves to indicate to one another which links/objects each is viewing.

A collaborative web browsing session enables a first person having a web-browsing session open to navigate on his or her computer (e.g. at home) and a second person having the session open to have a view that is updated contingent upon the first person's activities. Likewise, the second person can navigate independently on his or her machine (e.g. at work) and the first person's view will be updated. The two users' views will update upon the other's received navigation information. The extent of the updating is dependent on the navigation information/data that is exchanged.

According to one embodiment of the invention a web site (e.g. host server) is enabled to support and implement a collaborative browsing session. The web page is enabled to detect user devices that are enabled to participate in a collaborative web browsing session. The session could be created in one of two ways (describe below) by having the web page give the user a specially formatted cookie which contains contact/session information including, e.g., contact information for the leader of the collaborative session at that URL. This leader of the session could be another user or the web page itself. These contacts would enable creation of a one-time collaborative web browsing session at that page.

First, the web site itself could be the leader of the URL sharing session by participating in the session as the leader. As a leader, the web site could drive the session via URL sharing. To join the session, a user device would send a request to the web site. The web site would accept and act as a participant in the session, adding the new user to the session. Either one or a plurality of users could join the web site driven session in this way. In this case a cookie used for passing information to the user device would need to contain the contact information of the web site participant.

Second, the web site could be enabled to host a collaborative browsing session (such as a collaborative shopping session) wherein the users (having enabled browsers) at the web site can be linked together by the server in a collaborative web browsing session. In this case, the cookie (given by the web site) would contain the user identifications of all the user devices that are participating in the session (via joining the session) at that web page/URL. In this case, all the users are leaders of sorts whose web browsers can be set to automatically accept new user requests. That is, a new user at the web site is allowed to join a session at that web site having other users. When the new user joins the session, he or she sends a request to all the other users currently in the session, which will accept the request. The users then can partake in a collaborative web browsing session wherein they are enabled to be informed of the other users' browsing activities (including chat messages, etc.) without necessarily having to follow the other users as they navigate away from the web page hosting the session (i.e. via strict URL sharing). Upon a user navigating away from a collaborative session web page, the session will be over for that user (i.e. the user is unlinked from that session).

The advantage of this implementation is that the web page (server) responsibilities are the same as in the above-described lead and follow paradigm (i.e. the collaborative session hosted by the web site is essentially peer to peer). Of course, as above, the web site could also host a session wherein users are joined to a more conventional URL sharing session, such that a user is a leader and other users are followers.

Referring now more particularly to the accompanying drawings, a preferred embodiment of the present invention will be described. The scope of the invention will be pointed out in the appended claims.

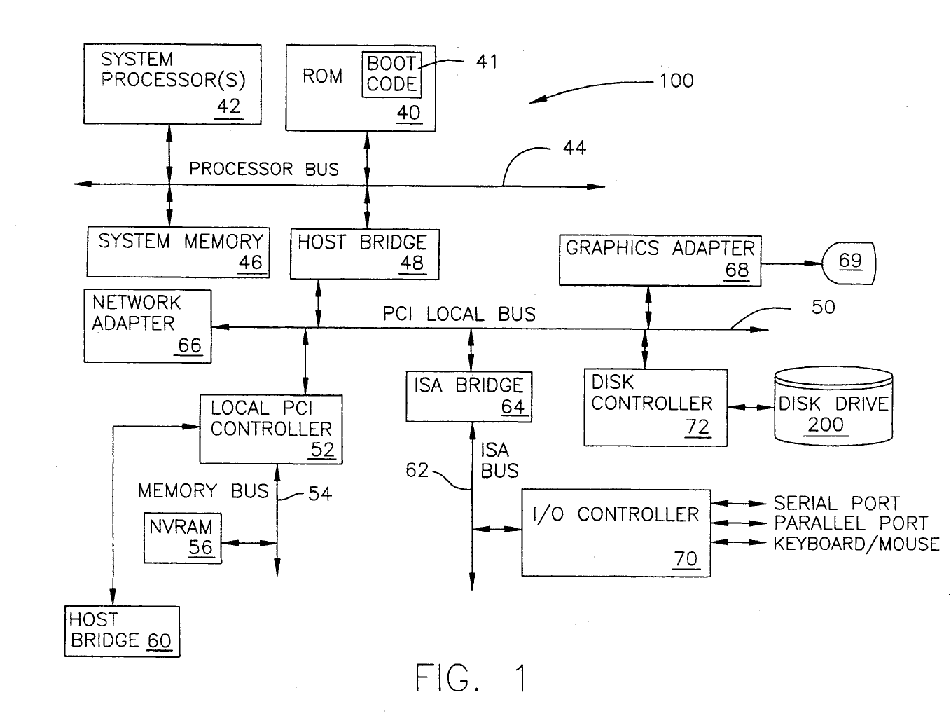

Referring now to FIG. 1, there is depicted a block diagram of an illustrative embodiment of a computer system 12. The illustrative embodiment depicted in FIG. 1 may be a notebook computer system, such as one of the ThinkPad® series of personal computers sold by Lenovo (US) Inc. of Purchase, N.Y. or a workstation computer, such as the Intellistation®, which are sold by International Business Machines (IBM) Corporation of Armonk, N.Y.; however, as will become apparent from the following description, the present invention is applicable to operation by any data processing system.

As shown in FIG. 1, computer system 12 includes at least one system processor 42, which is coupled to a Read-Only Memory (ROM) 40 and a system memory 46 by a processor bus 44. System processor 42, which may comprise one of the processors produced by Intel Corporation, is a general-purpose processor that executes boot code 41 stored within ROM 40 at power-on and thereafter processes data under the control of operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system 12 to LAN 10, and graphics adapter 68, which interfaces computer system 12 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 12 further includes Industry Standard Architecture (ISA) bus 62, which is coupled to PCI local bus 50 by ISA bridge 64. Coupled to ISA bus 62 is an input/output (I/O) controller 70, which controls communication between computer system 12 and attached peripheral devices such as a keyboard, mouse, and a disk drive. In addition, I/O controller 70 supports external communication by computer system 12 via serial and parallel ports.

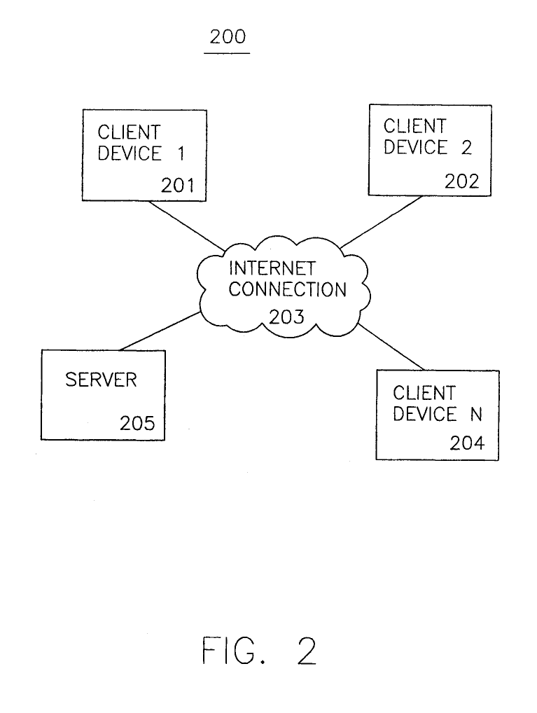

FIG. 2 shows a shared browsing system (200) in according to one embodiment of the present invention. The system (200) includes a plurality of client devices (e.g. computers) (201, 202, 204) connected a network (e.g. Internet 203) via a plurality of routers (not shown), and a server (205). The network may include a plurality of interconnected computer networks linked through wires/wireless connections. For example, the network may be selected from the Internet, an intranet, a wide area network (WAN), a local area network (LAN), an integrated services digital network (ISDN), or the like. The plurality of computers is in communication with the network.

Each computer (201, 202, 204) and the server (205) may include one or more processor modules and the like referred to herein as modules or components. The server (205) may also include a plurality of databases and a plurality of applications that constitute online web pages (e.g. online store). The server (205) is in communication with the plurality of computers (201, 202, 204) through the network. Each computer (201, 202, 204) further includes a display medium.

Additionally, each computer (201, 202, 204) includes software that includes a web browser. The web browser may be for example MICROSOFT INTERNET EXPLORER®, Mozilla Firefox, Apple Safari, NETSCAPE NAVIGATOR®, or the like. The web browser may automatically convert a plurality of HyperText Markup Language (HTML) codes in the form of corresponding text matter, one or more pictures/drawings, tables, hyperlinks, or the like and display the created web page in an intended format on the screen of the one or more computers (201, 202, 204).

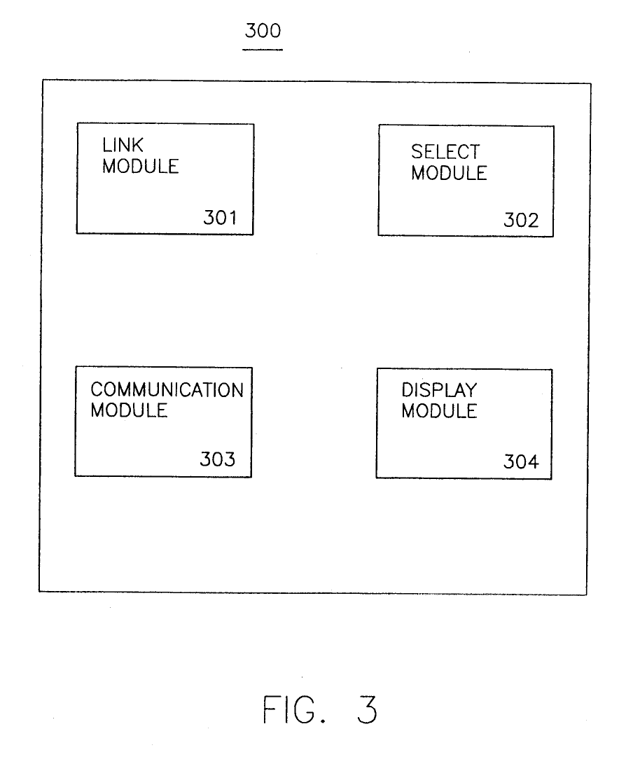

FIG. 3 is a block diagram of an apparatus (300) for establishing a collaborative web browsing session. The apparatus can be any suitable device but may be embodied in a device such as shown in FIG. 1 and is referred to as a peer device, client device, apparatus or computer. The apparatus contains a link module (301), a select module (302), a communication module (303) and a display module (304).

The link module (301) permits linking of a plurality of users (including a web site acting as an automated peer/user) for a collaborative browsing session. A user participating in the session is enabled to select a link or the like displayed by the display module (304) on his or her web browser for joining a collaborative web browsing session hosted by a web page using the select module (302). Upon selection, the communication module (303) allows the user to communicate (e.g. sending and receiving session joining information, URL sharing data, chat messages, etc.) with the other users participating in the web browsing session.

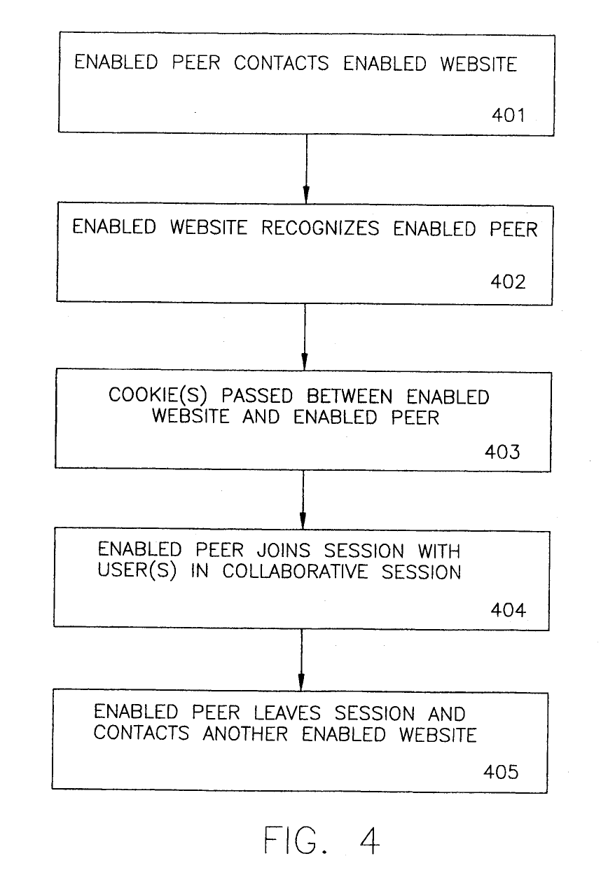

FIG. 4 is a flow chart depicting the joining of a collaborative web browsing session by a peer device. A peer enabled for collaborative web browsing (401) contacts a web site that is enabled to support collaborative web browsing. The web site recognizes/detects that the peer is enabled to support collaborative web browsing (402). The web site passes a cookie (403) to the enabled peer in order to give the peer information necessary to join a collaborative web browsing session being conducted at the web site. The enabled peer is thus capable of joining the collaborative web browsing session that contains at least one other user. The one other user may be the web site itself (described below) or other enabled peer devices (described below). Upon leaving the web site (via clicking on a link), the enabled peer can essentially repeat steps 401-404 to establish a new browsing session with another enabled web site (405).

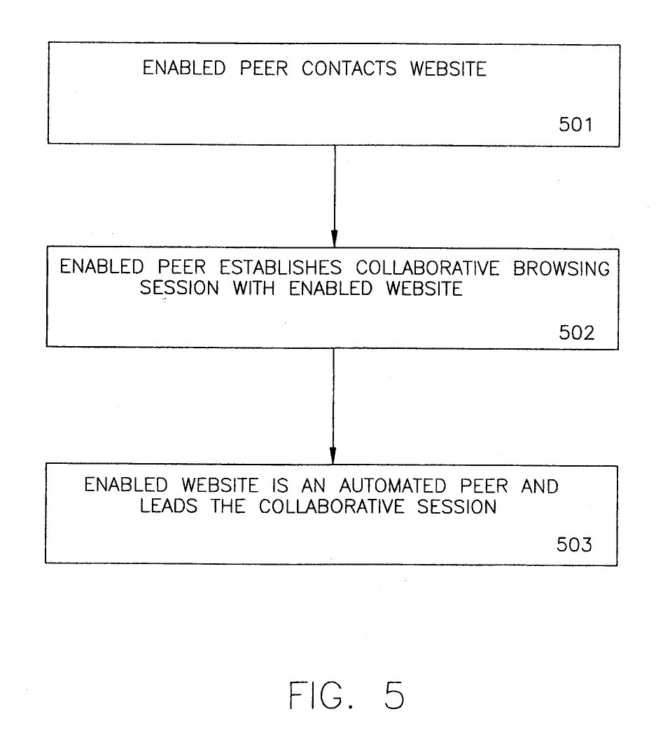

FIG. 5 is a flow chart depicting a collaborative web browsing session driven by the web site itself. An enabled peer contacts an enabled web site (501). Upon contact the enabled web site again recognizes the enabled peer. The enabled peer then provides information to the enabled web site to join the session (e.g. by typing in a session name or clicking on a button at the web site). The enabled peer then establishes a collaborative browsing session with the web site (502) such that the web site is joined to the peer device as an automated peer. As an automated peer, the web site drives the collaborative web browsing session (503) by passing URL information to the other user(s) in the collaborative web browsing session.

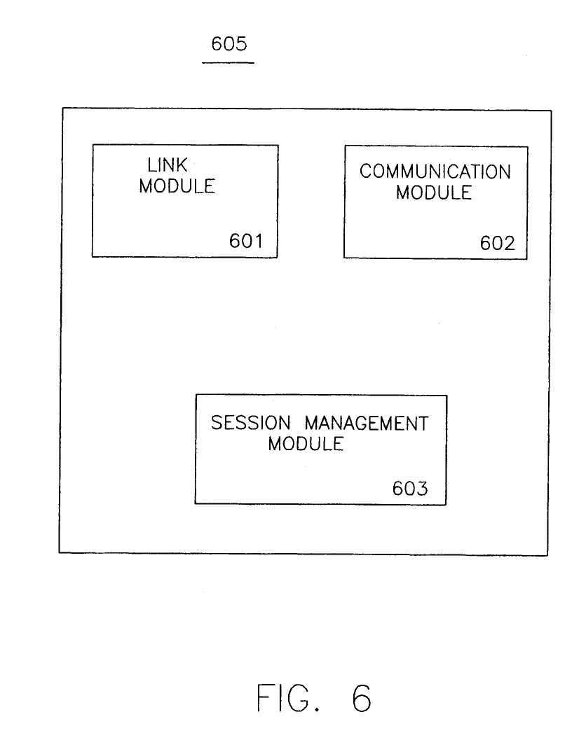

FIG. 6 is a block diagram of a server (605) (e.g. a web server) that can host a collaborative web browsing session including joining itself as a user/automated peer in the session to drive the session via collaborative sharing of URLs. The server hosts web pages that are enabled to support collaborative web browsing sessions and enabled to detect enabled peer devices. The server includes a link module (601), a communication module (602) and a session management module (603).

The link module (603) enables the server (605) to link with at least one other user or client device at web page hosted by the server (600). The user device is enabled to engage in collaborative web browsing and may thus be linked to the server (605) (joined into a collaborative session with the web page itself and/or other users). The communication module (602) allows the server to communicate with the other peer/user devices in the collaborative web browsing session for sharing session information (cookies) and/or URLs (i.e. to drive the session). The server (605) may thus be programmed to join users in a session, share session information and drive a session via the session management module (603).

According to one embodiment of the present invention a web page itself is allowed to actually direct the navigation flow of the collaborative web browsing session as an automated peer. Permitting a web page or other server application to direct the collaborative session has many advantages. Among the advantages are at least a use for slide shows presentations or any number of group presentations or the like where it is useful to have the web page itself directing everything involved with the session. Thus, the web page itself joins the session as an additional member and the session becomes automated. The web page instructs all of the users in a particular session to go here and go there, etc. The users have their views updated accordingly.

Web pages are capable of causing browsers to redirect in an automated fashion. Common examples include a login web page that redirects a user's web browser to a page upon proper login or a web page that redirects a user's browser to a receipt page after the user has submitted credit card data. At least one way of accomplishing this redirection is the use of JAVA script.

According to an embodiment of the invention, a web page is enabled to join a collaborative web browsing session as a participant and provide directions (e.g. URLs or redirects) to users' browsers in order to control the navigation of the session. For example, a slide show appearing on a web page in the session may be redirected to another web page upon a predetermined time elapsing (e.g. after five seconds—go here). Then that view is simply propagated to all the different users in the session and the web page member of the session is doing the driving (redirection and propagation via URL sharing).

According to one embodiment of the invention the web site itself is essentially joining as any other peer would join a URL sharing session. Thus the web site participant is an automated peer joining the session. To join the session at the web site, a user would send a request to the web site participant (i.e. the web site that is going to be a member of the session and participate as the leader of the session). The web site would accept as an additional member of the session, as any other user. Other users could likewise join in the session as their devices are enabled to join the collaborative browsing session.

Those skilled in the art will understand that there is any number of ways to join users in a collaborative web browsing session (e.g. passing join and accept requests between the users devices/computers). Those skilled in the art will also understand that there is any number of ways for allowing the web site participant to join the collaborative browsing session. For example, the web site participant could have a button that when pressed/clicked by a session user (i.e. in their browser display) visiting the web site allows the web site participant to join the session. According to this embodiment, if the users are already participating in a session and join the web site participant by clicking the button to add the web site participant to the session, only one such users needs to join the web site. Alternatively, the session may be named and a user could input into a dialog or text box available at the web site (displayed on the users browser display) the session name, whereby the web site participant joins the named session.

According to one embodiment of the invention, there is only a need for one person to explicitly link this automated peer/web site participant into the session. Thus, if one user goes to the web site, every other user in the session also goes to the web site (via URL sharing). If a user clicks the button to add the web site participant to the session, every other user in the session (by knowing the IP address of the web site participant via a cookie given by the web site) will have the web site participant joined. Thus, every user in the session is in a linked session, making adding the web site participant an easy step resulting in an automated or semi-automated session.

As a non-limiting example, for a slide show or a presentation, the web site participant directs users to a new web page via URL sharing to see some photographs hosted online and/or diagrams hosted online (i.e. in web pages). The web site participant directs users to additional web sites according to a predetermined schedule of events. Thus, the web site participant directs users through a set of web sites that form a presentation for all the users (peer devices) participating in the collaborative session.

An embodiment of the instant invention is very useful in the case of going to a help center. The server hosting the web site participant decides/drives the user(s) that is/are joining the session (i.e. linking peer-to-peer). For example, if a help desk has 10 help desk technicians, the server can direct the joining of a user device to one particular technician for a collaborative browsing session. This allows a user to not only establish a chat session with the help desk technician (e.g. via a chat window/tab in the browser display) but also enables the help desk web site to become a participant in a collaborative browsing session and to drive the user (i.e. the user's web browser) to the correct web site that has the information the user needs to solve a particular problem. If the help desk technician is enabled to join and drive a collaborative browsing session via being linked to the user by the web site participant.

According to another embodiment of the invention, a cookie contains the user IDs of all the users at the URL. Upon entry to an enabled web site, users of enabled peer devices may be joined together by the web site in a collaborative web browsing session. This session could take many forms, including traditional URL sharing (i.e. leader-follower) or sharing navigation data (i.e. no particular leader). In one case, the users are all potential leaders and their session browsers are set to automatically accept new user requests (i.e. from users wishing to join). In this case, every user that is going to participate in the collaborative session on the web page gets linked up together in the collaborative session by the web site hosting the session. When a new user joins the session at the web site, he or she sends to all of the users currently in the session (such that there are any) a request to join. At least one advantage of such a scenario is that the session server responsibilities are the same as/compatible with the traditional “leader” and “follower” model of the above-described URL sharing system.

An embodiment of the present invention may be provided as a computer program product which may include a machine-readable medium having stored thereon instructions which may be used to program a computer (or other electronic devices) to perform a process according to the any of the embodiments of the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media/machine-readable medium suitable for storing electronic instructions. Moreover, an embodiment of the present invention may also be downloaded as a computer program product, wherein the program may be transferred from a remote computer to a requesting computer by way of data signals embodied in a carrier wave or other propagation medium via a communication link (e.g., a modem or network connection).

Elements of the instant invention may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

In the drawings and specification there has been set forth a preferred embodiment of the invention and, although specific terms are used, the description thus given uses terminology in a generic and descriptive sense only and not for purposes of limitation.

If not otherwise stated herein, it is to be assumed that all patents, patent applications, patent publications and other publications (including web-based publications) mentioned and cited herein are hereby fully incorporated by reference herein as if set forth in their entirety.

Many of the functional units described in this specification have been labeled as modules in order to emphasize their implementation independence. Modules may include hardware circuits such as one or more processors with memory, programmable logic, and/or discrete components. The hardware circuits may perform hardwired logic functions, execute computer readable programs stored on tangible storage devices, and/or execute programmed functions. The computer readable programs may in combination with a computer system perform the functions of the invention.

What is claimed is:

1. A system comprising:
a CPU;
a memory in communication with the CPU;
instructions stored in the memory and executable by the CPU to establish a collaborative web browsing session, the instructions further comprising:
instructions enabling at least one peer device to join the collaborative web browsing session at a web site hosted by an automated peer.

2. The system according to claim 1 wherein the instructions further comprise:
instructions enabling the automated peer to join a plurality of peer devices together in the collaborative web browsing session by giving the plurality of peer devices session contact information.

3. The system according to claim 2 wherein the collaborative web browsing session enables the plurality of peer devices to be linked peer to peer in the collaborative web browsing session.

4. The system according to claim 2 wherein the session contact information further comprises:
a user identification for at least one session peer currently engaged in the collaborative web browsing session.

5. The system according to claim 4 wherein the session information further comprises:
information enabling the plurality of peers to populate session lists containing the contact information of the at least one session peer currently engaged in the collaborative web browsing session.

6. The system according to claim 1 wherein the instructions further comprise:
instructions enabling the automated peer to automatically recognize the at least one peer device as being enabled to participate in the collaborative web browsing session.

7. The system according to claim 3 wherein the instructions further comprise:
instructions enabling the plurality of linked peers to engage in a collaborative web browsing session wherein the plurality of linked peers maintain navigation independence.

8. The system according to claim 7 wherein if one of the plurality of linked peers engaged in a collaborative web browsing session navigates away from a web site hosted by the automated peer, the one of the plurality of linked peers is unlinked from the collaborative web browsing session.

9. The system according to claim 1 wherein the automated peer is enabled to lead an automated collaborative browsing session via URL (Uniform Resource Locator) sharing with the at least one peer device.

10. A method comprising:
enabling at least one peer device to join the collaborative web browsing session at a web site hosted by an automated peer.

11. The method according to claim 10 further comprising:
enabling the automated peer to join a plurality of peer devices together in the collaborative web browsing session by giving the plurality of peer devices session contact information.

12. The method according to claim 11 wherein the collaborative web browsing session enables the plurality of peer devices to be linked peer to peer in the collaborative web browsing session.

13. The method according to claim 11 further comprising:
wherein the session contact information further comprises:
a user identification for at least one session peer currently engaged in the collaborative web browsing session.

14. The method according to claim 13 wherein the session information further comprises:
information enabling the plurality of peers to populate session lists containing the contact information of the at least one session peer currently engaged in the collaborative web browsing session.

15. The method according to claim 10 further comprising:
enabling the automated peer to automatically recognize the at least one peer device as being enabled to participate in the collaborative web browsing session.

16. The method according to claim 12 further comprising:
enabling the plurality of linked peers to engage in a collaborative web browsing session wherein the plurality of linked peers maintain navigation independence.

17. The method according to claim 16 wherein if one of the plurality of linked peers engaged in a collaborative web browsing session navigates away from a web site hosted by the automated peer, the one of the plurality of linked peers is unlinked from the collaborative web browsing session.

18. The method according to claim 14 wherein the automated peer is enabled to lead an automated collaborative browsing session via URL (Uniform Resource Locator) sharing with the at least one peer device.

19. A program storage device readable by machine, tangibly embodying a program of instructions executable by the machine to perform a method comprising:
enabling at least one peer device to join the collaborative web browsing session at a web site hosted by an automated peer.
